(19) United States
(12) Patent Application Publication
(10) Pub. No.: US 2019/0088155 A1
(43) Pub. Date: Mar. 21, 2019

(54) CONCEPT MAP ASSESSMENT

(71) Applicant: Hewlett-Packard Development Company, L.P., Fort Collins, CO (US)

(72) Inventor: Lei LIU, Palo Alto, CA (US)

(21) Appl. No.: 15/763,019

(22) PCT Filed: Oct. 12, 2015
(86) PCT No.: PCT/US2015/055168

§ 371 Date: Mar. 23, 2018

(51) Int. Cl. G09B 7/04; G09B 7/12

(52) U.S. Cl. CPC G09B 7/04; G09B 7/12

(57) ABSTRACT

Concept map assessment includes receiving a first concept map from a learner and preparing an assessment of the first concept map for a learner based on at least one of: an amount of edge differences and an amount of path differences between the first concept map and a second concept map, a similarity detection system to detect similarity in text between the first concept map, the second concept map and learning content, and peer-review of the first concept map by other learners and reviews of the peer-reviews by the learner of other learners' first concept maps.

### BACKGROUND

Many online and college level courses are taught to large number of student learners by single or a small group of teacher instructors. Classical testing and assessment techniques rely on quizzes, tests, and essays. Due to the large number of learners, quizzes and tests tend to be multiple choice, which requires considerable testing and selection of the questions via statistical evaluation in order for the multiple choice question to be a reliable and effective assessment tool.

### BRIEF DESCRIPTION OF THE DRAWINGS

The disclosure is better understood with reference to the following drawings. The elements of the drawings are not necessarily to scale relative to each other. Rather, emphasis has instead been placed upon clearly illustrating the claimed subject matter. Furthermore, like reference numerals designate corresponding similar parts through the several views.

FIG. 1 is an example flow chart of an educational environment in accordance with this disclosure;

FIG. 2A is an example concept extraction of key concepts and edges;

FIG. 2B is an example reference concept map;

FIG. 3 is an example physical implementation of a system to perform concept map assessment;

FIG. 4 is an example of the auto-assessment using a reference concept map of an instructor and multiple learner concept maps;

FIG. 5A is an example reference concept map created by an instructor;

FIG. 5B is an example assessment test of the candidate key concepts and the candidate type of edges;

FIG. 6 is an example path score calculation based on a concept mapping network;

FIG. 7 is a screen shot of one example assessment system;

FIG. 8 is an illustration of an example screenshot for concept edge relation construction by a learner;

FIG. 9 is an illustration of an example screenshot for the peer concept map assessment module in FIG. 1;

FIG. 10 is an example illustration of screenshot for the review reviewers module in FIG. 1;

FIG. 11 is an example illustration of an assessment dashboard in a Heat Map view;

FIG. 12 is an example illustration of an alternative instructor dashboard in a table view;

FIG. 13A is an example non-transitory computer readable medium;

FIG. 13B is an example set of possible additional instructions on non-transitory computer readable medium of FIG. 13A;

FIG. 14A is an example method for concept map assessment; and

FIG. 14B is an example set of possible additional methods for the example method in FIG. 14A.

### DETAILED DESCRIPTION

Alternatively to multiple choice tests, essay tests potentially provide one free-form or open-ended method for an instructor to assess the deep level understanding of the learner. However, such essay tests require manual grading and when done with large number of students, they typically have to be graded (assessed) by several individuals and subjective differences among the graders lead to inconsistent scoring and thus is a low quality assessment technique. Accordingly, existing educational open-ended assessment techniques are not easily extended to large sets of people due to resource constraints and differences among graders. For example, in massively open online courses (MOOC) there may be thousands of students that are enrolled in a single class and manual open-ended assessment is simply not timely nor realistic. There is no present open-ended assessment method that provides for consistent and fair scoring that is cost effective.

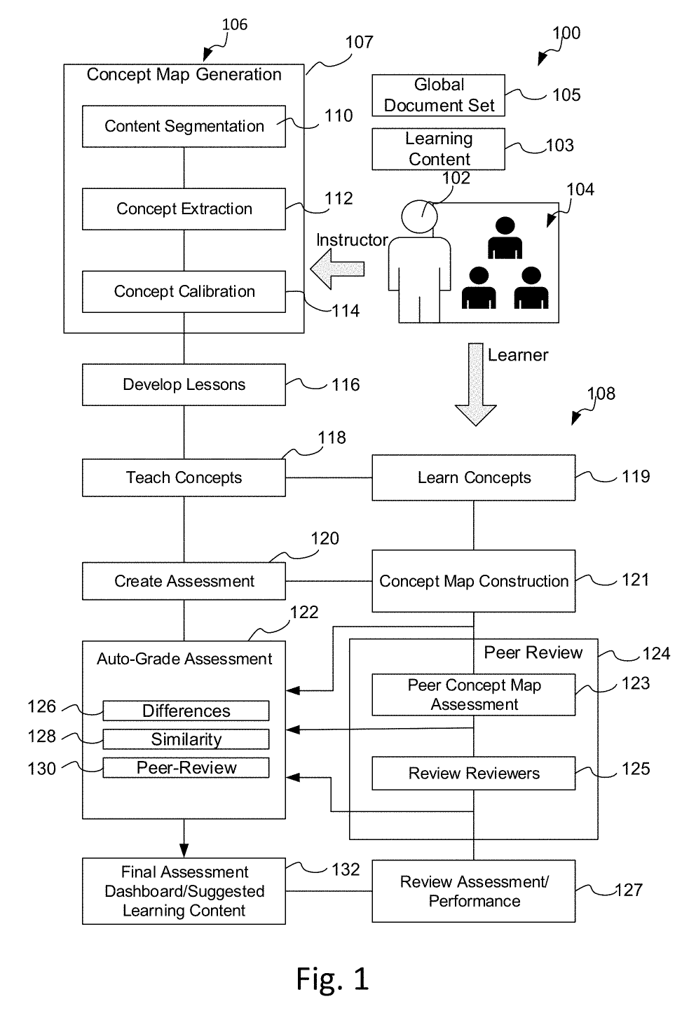

FIG. 1 is an example flow chart of an educational environment 100 to provide an overview of the following discussion. An instructor 102 educates one or more learners 104 using learning content 103, such as books, lecture notes, references, articles, etc. from a global document set 105. The flow chart has two columns, a left column 106 which includes possible steps an instructor 102 may use to automate the assessment of learners 104, and a right column 108 which includes possible steps a learner 104 may use to learn and demonstrate that learning via assessment.

Concept map testing is another worthy open-ended testing method for a learner to demonstrate their deep level understanding of targeted learning content. Relating new concepts to what is already known by the learner 104 helps to trigger meaningful deep learning. Learners 104 reveal their in-depth knowledge using concept maps by creating or choosing concepts and drawing edges and labeling the edges between concepts to show relationships. An instructor 102 then examines the learner concept maps, evaluates the quality of the concept map, and assigns a score. However, like other testing techniques, prior concept map grading is primarily done manually and presents a heavy workload to the instructor 102. Thus, it has been impractical with large numbers of learners 104. While multiple graders are one way to address the workload, the differing subjective judgment of the graders leads to unfair or inconsistent testing.

Presented within is a computer-implemented system and method for automating with software and computer processors the creation and assessment of concept or other content maps, also sometimes referred to as mind maps. By automating one or more of the various processes to create and assess concept maps, the workload of the instructor 102 may be significantly reduced. Additionally, learners can mentally focus their creativity and thought into generating concept maps rest assured that their concept maps are automatically and objectively assessed (graded or scored) consistent, fair, and relatively fast.

In addition, as a technique to increase one's learning retention rate, peer-review by the learners 104 and peer-feedback to the peer-reviewers is also available as learning and understanding are significantly increased by teaching others. Peer-review helps the learners 104 to increase their understanding or comprehension of the material by not only seeing how other learners 104 are understanding the material but also by having the learners 104 articulate their understanding of the conceptual relationships back to the peer-learner under review. Accordingly, in one example, each learner 104 plays two roles: learner and peer-reviewer. In this peer-review example, each learner 104 is evaluated by at least two factors: first, how well the learner has constructed concept relationships as scored by other peer-reviewers; and second, how well the learner's review comments help others as scored by other learners' feedback about the learner peer-review comments.

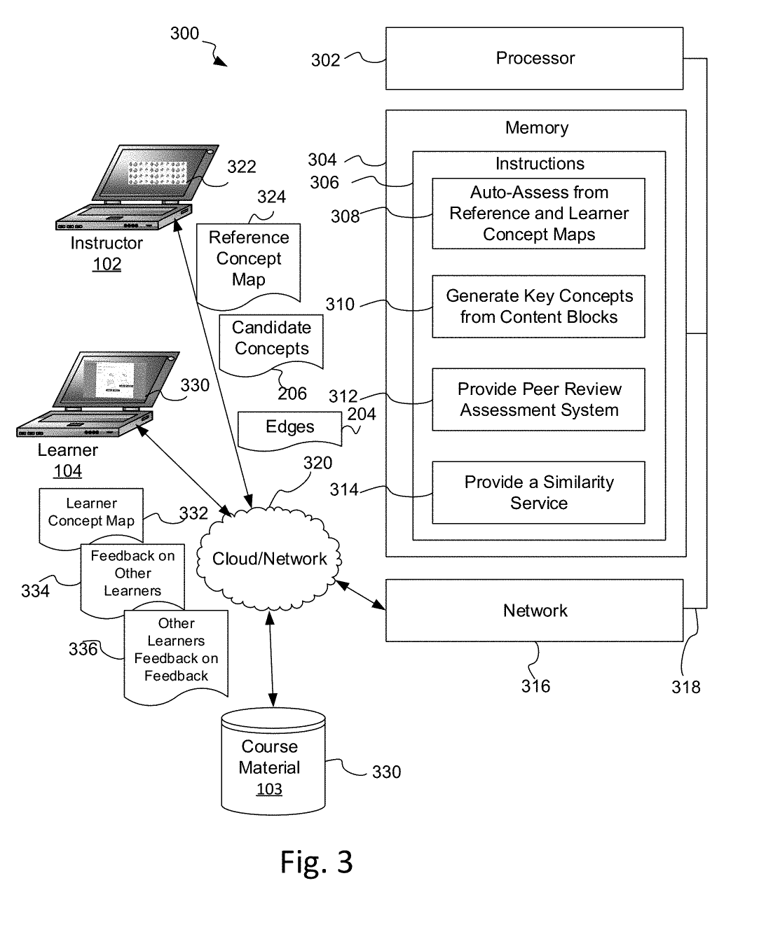

The computer-implemented systems and methods disclosed herein are able to automatically detect the relative importance of the various concepts and relationships and incorporate that information into the assessment. The importance is determined based on the relative importance of the concepts within the learning content 103, such as course material, books, lecture notes, references, articles, etc. Further, a “ground truth” or reference concept map 324 (FIG. 3) of the learning content 103 may be automatically generated for the instructor 102 by a computer-implemented automatic content extraction module 112. The instructor 102 may modify the reference concept map 324 by editing, adding, and deleting concepts and edges as best reflects the instructor's knowledge and teaching of the learning content 103. For instance, the instructor 102 may add any concepts which failed to be identified by the automatic concept extraction module 112 that the instructor 102 would like to include within the concept map. The instructor 102 may also edit the concepts that are automatically identified with the instructor's own preference. Of course, in some examples the instructor 102 may create their own reference concept map 324 without automation.

The assessment of a learners' test is done in comparison to difference and/or similarity matching with the reference concept map 324. Accordingly, the concept map matching may be done in at least one of multiple ways. In one example, the difference matching is done by matching the connection of edges between pairs of concepts in the learner's concept map 332 (FIG. 3) and the corresponding pair of concepts in the instructor's reference concept map 324 and noting differences. In another example, similarity matching is done using summarization techniques to detect similarity between the learner's concept map 332, the instructor's reference concept map 324, and the learning content 103. In yet another example, peer-review grading with peer feedback is done to provide an alternative or supplemental test assessment. Various other options and techniques for improving fairness and flexibility are described within to help the instructor 102 prepare and assess a learner's understanding of learning content 103. For instance, based on the assessment, the computer-implemented system and method may allow the instructor 102 to automatically suggest additional learning content 103 to the student based on where the instructor's and learner's concept maps differ.

To help ease understanding, clarity, and conciseness, the following definitions will be used for discussion of additional details of the concept map assessment discussed herein unless context requires otherwise or the term is defined explicitly differently. The following definitions are not meant to be a complete definition of the respective terms but rather is intended to help the reader in understanding the following discussion.

Concepts—A concept is a labeling of an abstract idea, a plan, an instance, or some general notion generally formed by combination of characteristics or particulars of intuitive thought. Concepts may range from a collection of general to very detailed specific groupings or dissections of content. Concepts are generally labeled in a box, circle, nodes, cells, or other geometric form for visualization. Concepts may also include textual summaries beyond labeling and the textual summaries may include information on how particular labeled concepts related to other labeled concepts.

Edges—Edges are lines which are used to connect concepts and can be labeled text to show relationships between concepts. The edges may also be with directions noting hierarchy or they can be undirected.

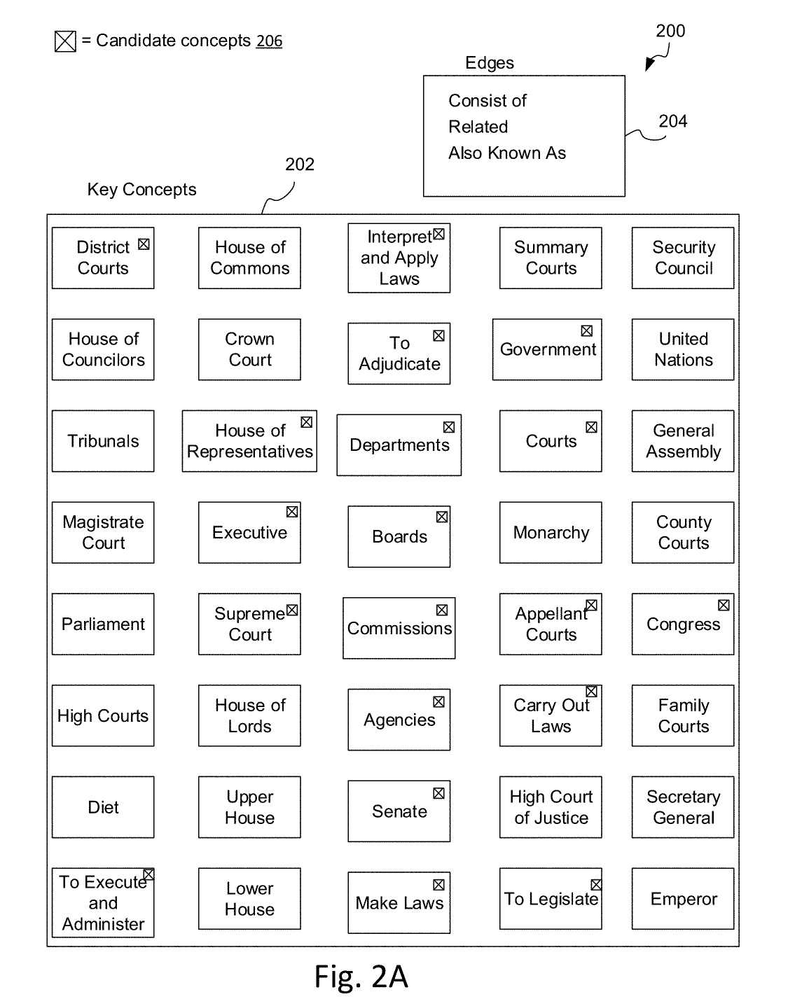

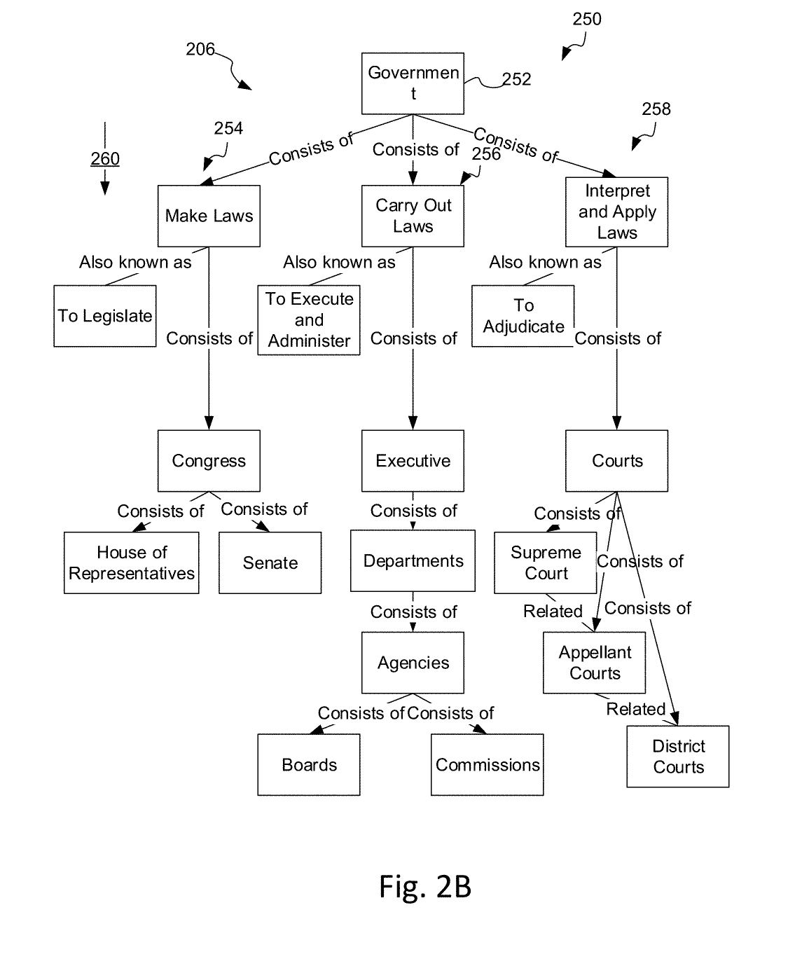

Concept Maps—A concept map is a form of a structure diagram that illustrates conceptual knowledge and their relationships. The structure diagram may be hierarchical in some examples and not hierarchical in other examples. The concept map represents relationships among different concepts within a specific topic and in some instances may show relationships from general to specific concepts. A concept includes concept labels or summaries that are connected together by edges to other concept. One example concept map is a flow chart that is widely used in business to gain an insight on the overview idea being constructed. Other example concept maps are used to brain-storm new ideas and developments. For instance, FIG. 2B is an example concept map for government organization.

Learner—A student, apprentice, observer, or other individual that is working on acquiring knowledge in new or familiar topical areas.

Instructor—A teacher, professor, educator, mentor, or other individual who possesses or communicates knowledge that learners wish to absorb and understand.

Assessment—A test, quiz, essay, competition, exercise, examination, or other evaluation used to assess a learner's understanding of taught material.

Learning content—The educational material put forward by an instructor or other individual that contains the targeted learning material for the learners to review, absorb, and understand to acquire in-depth knowledge of the subject matter in order to understand the targeted concepts and the relations between them. It may include course material, books, lecture notes, references, articles, etc. from a global document set as just some examples.

Summary—A description of the relationship between differing concepts and their relations. The summary may be in addition to the labeled concepts and edges or in place thereof. Summaries may be textual blocks which are amenable to summarization techniques to determine textual similarities.

The instructor 102 may auto-create a reference concept map within a concept map generation module 107 using a content segmentation module 110 to automatically parse and segment the learning content 103 into various content blocks. The content blocks may then be further examined with a concept extraction module 112 to mine and group concepts and edges within the content blocks. A concept calibration module 114 allows an instructor 102 to modify, such as by editing, adding, or deleting, etc. the auto extracted concepts and edges based on his/her preferences or intimate knowledge of the subject matter. The instructor 102 then develops lessons 116 and teaches the concepts 118 to the learners 104 and creates assessments 120 using the concept material.

The learner 104 in turn learns concepts 119 and demonstrates that learning by taking the assessment from instructor 102 which requires the learner 104 using a concept map construction module 121 to construct a learner concept map. The completed learner concept map is given to the instructor 102 to so that it may be evaluated and assessed in the auto-assessment module 122. The auto-assessment module 120 may perform the grading using one or more techniques, such as using differences 126, similarity 128, and/or peer-review 130.

In some examples, the learner concept map may also be presented to the peer concept map assessment module 123 for peer-review by other learners for ratings and/or comments. The reviews by other learners is then presented to learner 104 in the review reviewers module 125 to allow for feedback ratings to individual other learners on how helpful their peer-reviews on the learner's concept map were to the learner 104. In some examples, the peer reviews are also communicated to the auto-assessment module 122 to allow for augmentation or incorporation into the learner's performance assessment and grading.

Accordingly, the instructor 102 may review the assessed test result along with the peer-review comments and feedback on the peer-reviews to arrive at a final assessment for the learner. In some examples, there may be a final assessment dashboard module 132 that the instructor 102 can use to view the overall assessments of the learners 104 in the class and to provide new suggested learning content material to each learner 104 based on the final assessment and how the learner's concept map compared to the instructor's reference concept map. The learner 104 may use the review assessment/performance module 127 to review the final assessment and any new suggested learning content material provided by the instructor 102 from the suggested learning content suggested in module 132.

For instance, FIG. 2A is an example concept extraction 200 of key concepts 202 and edges 204 from a civics course that is focused on government organization. The learning content 103 may include several concepts in government organization for each country and/or assembly of nations and may include different yet similar functions and names for organizations carrying out those functions. Listed here are some example content from United States, United Kingdom, Japan, and United Nations governing bodies. A set of edges 204 may also be used to describe how the different concepts are inter-related. An instructor 102 may select one or more key concepts 202 to provide candidate concepts 206 (denoted here with a box with an “x” in the upper right corner for the United States government) used for assessing learner knowledge.

FIG. 2B is an example reference concept map 250 which illustrates one example of how an assessment test using the candidate concepts 206 on the United States government might be organized based on the teachings of the instructor 102. In this example, there are three columns which represent various branches of the government 252, the legislative column 254, the executive column 256, and the judicial column 258. Arrow 260 illustrates the direction of the hierarchy from top to lower levels. As the candidate concepts 206 are placed on the page, further down in the page generally represents lower positions in the hierarchy. Each of the candidate concepts 206 is paired with other candidate concepts 206 in the same or next hierarchical level and labeled with an edge 204 to show relevance, such as “consists of” (includes), “also known as”, and “related” in this example and direction as with “consists of”.

FIG. 3 is an example physical implementation of a computer-implemented system 300 to perform concept map assessment. A processor 302 is communicatively coupled via channel 318 to a non-transitory computer readable medium (CRM) such as memory 304 which contains instructions 306 that when read and executed by the processor 302 cause the processor 302 to perform operations. For instance, the instructions 306 may include one or more modules to allow for automating the concept map assessment, such as a first module 308 to provide an auto-comparison assessment from a provided reference concept map 324 and a learner concept map 332. A second module 310 may generate key concepts 202 and edges 204 from content blocks. A third module 312 may provide a peer-review assessment system. A fourth module 314 may provide a similarity service that uses summarization techniques to compare reference concept map 324 and learner concept map 332 to detect textual similarities. The modules 308-314 may be called singularly or in combination depending on the needs and requests of the instructor 102.

In other examples, the modules may be implemented in software, firmware, or logic as one or more modules and sub-modules alone or in combination as best suits the particular implementation. Further the modules may be implemented and made available in standalone applications or apps and also as application programming interfaces (APIs) for web or cloud services. While a particular example module organization is shown for understanding, those of skill in the art will recognize that the software may be organized in any particular order or combinations that implements the described functions and still meet the intended scope of the claims.

The CRM may include a storage area for holding programs and/or data and may also be implemented in various levels of hierarchy, such as various levels of cache, dynamic random access memory (DRAM), virtual memory, file systems of non-volatile memory, and physical semiconductor, nanotechnology materials, and magnetic/optical media or combinations thereof. In some examples, all the memory may be non-volatile memory or partially non-volatile such as with battery backed up memory. The non-volatile memory may include magnetic, optical, flash, EEPROM, phase-change memory, resistive RAM memory, and/or combinations.

The processor 302 may be one or more central processing unit (CPU) cores, hyper threads, or one or more separate CPU units in one or more physical machines. For instance, the CPU may be a multi-core Intel™ or AMD™ processor or it may consist of one or more server implementations, either physical or virtual, operating separately or in one or more datacenters, including the use of cloud computing services.

The processor 302 is also communicatively coupled via channel 318 to a network interface 316 or other communication channel to allow interaction with the instructor 102 via an instructor client computer 322 and one or more learners 104 and their respective learner client computer 330. The client computers may be desktop, workstations, laptops, notebooks, tablets, smart-phones, personal data assistants, or other computing devices. In addition, the client computes may be virtual computer instances. The instructor client computer 322, the learner client computer 330 and the network 316 are coupled via a cloud network 320, which may be an intranet, Internet, local area network, virtual private network, or combinations thereof and implemented physically with wires, photonic cables, or wireless technologies, such as radio frequency and optical, infra-red, UV, microwave, etc. In some examples, the cloud network 320 may be implemented at least partially virtually in software or firmware operating on the processor 302 or various components of the cloud network 320. In some examples, the learning content 103 may be stored on one or more databases 330 and coupled to the cloud network 320. In other examples, the learning content 103 may be stored in memory 304 or other processor coupled memory or storage for direct access by the processor 302 without use of the network interface 316.

In one example, a memory 304 is coupled to the processor 302 and the memory 304 includes instructions 306 that when read by the processor 302 cause the processor 302 to perform at least one of the operations to: a) provide a set of key concepts 326 and a fixed set of edges 204 to allow learners 104 to create a learner concept map 332 and automatically compare the learner concept map 332 to a reference concept map 324; b) generate 308 the set of candidate concepts 206 from content blocks in a set of learning content 103 in a database 330 and to allow learners 104 to connect pairs of candidate concepts 206 with edges 204 defining the pairs of candidate concept 206 inter-relationships; c) provide a peer-review assessment system 312 to the learners 104 to review and provide feedback 334 to a set of other learner concept maps and to allow the learner 104 to review feedback from other learners for the learner concept map and provide 326 feedback on feedback ; and d) provide a similarity service 314 using summarization techniques to detect similarities and/or differences between the learner concept map 332, the reference concept map 324 and the set of learning content 103 in the database 330.

Providing the set of candidate concepts 206 and a fixed set of edges 204 may be implemented by having the learning content 103 segmented into a set of content blocks using content segmentation 110. The content blocks are extracted by the processor 302 using the various table of contents in the learning content 103 and/or topic distribution within the learning content 103 using semantic content segmentations. Then, for each content block, the underlying key concepts are extracted by the processor 302 in concept extraction module 112. The key concepts may be extracted from the concept blocks using one or more of a) word frequency analysis, b) using a document corpus, c) word co-occurrence relationships, d) using lexical chains, and e) key phrase extraction using a Bayes-classifier.

Key concept extraction may not provide exactly the key concepts depending on the learning content 103 and the key concept extraction techniques used. Accordingly, concept calibration module 114 can be used to allow the instructor 102 to modify the extracted key concepts to allow specific concepts/terms the instructor 102 wants to emphasize based on their teaching experiences. In concept calibration, the processor 102 provides a user interface, such as a graphical user interface (GUI) to the instructor's client computer 322 to allow for adding, deleting, and editing the key concepts and/or the fixed set of edges.

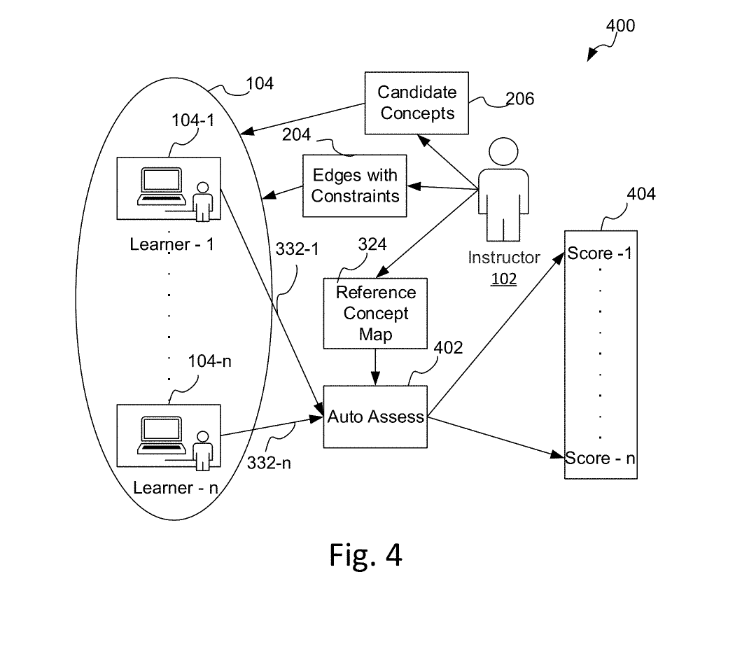

FIG. 4 is an example of the auto-assessment using the reference concept map 324 of the instructor 102 and the multiple learner concept maps 332-1 to 332-n from learners 104-1 to 104-n. The instructor 102 may use the automatic generate concepts from content blocks module 310 to provide a set of candidate concepts 206 and a set of edges with constraints 204. In other examples, the instructors may create their own set of candidate concepts 206 and set of edges with constraints 204 based on their own knowledge and/or from their own created reference concept map 324. The learners 104 receive the set of candidate concepts 206 and the set of edges with constraints and proceed to create their own learner concept maps 332-1 to 332-n. The auto-assess module 402 receives the reference concept map 324 and the learner concept maps 332-1 to 332-n. Using one or more assessment techniques described within, the auto-assessment module 402 evaluates or otherwise assesses the learners 104-1 to 104-n to create a set of scores 404 for each learner, such as score-1 for learner 104-1 and score-n for learner 104-n.

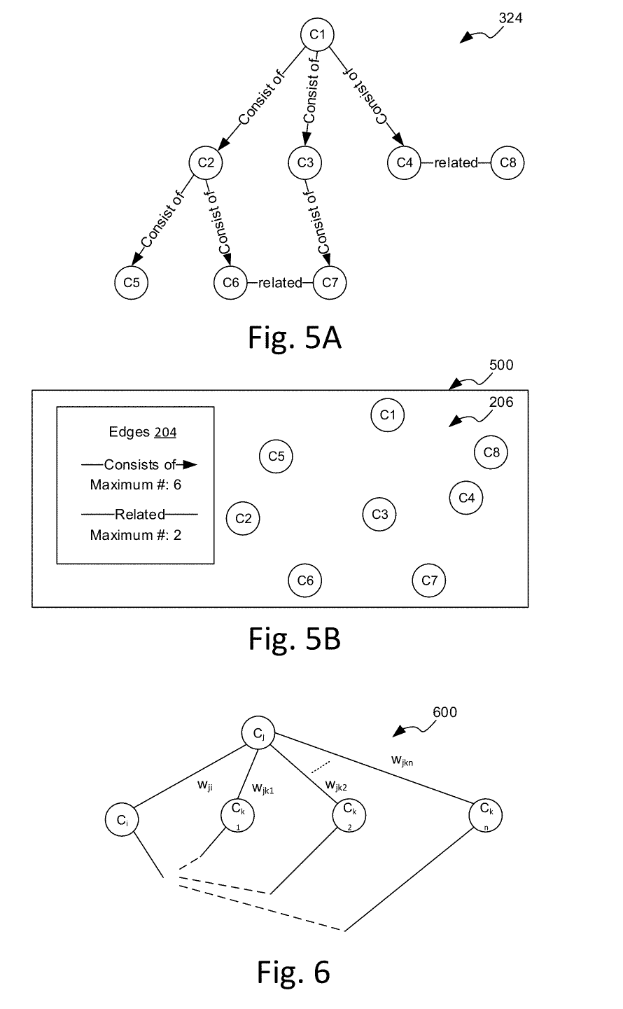

For instance, FIG. 5A is an example reference concept map 324 created by an instructor 102. The key concepts 326 include concepts C1-C8 and two types of edges 204, “Consists of” and “related” where the “Consists of” is directed and the “related” is undirected. The instructor 102 may select and modify which of those candidate concepts 206 are to be included in the learner's concept map 332 during assessment. That is, the learner 104 will need to use all the candidate concepts 206 from the instructor 102 and part or all of the types of edges 203 provided by the instructor 102. In other examples, the instructor may provide additional candidate concepts that are not included in the reference concept map 324 to make the assessment more difficult, such as by having false or “red-herring” concepts that may confuse an unprepared learner 104 or one who lacks deep understanding.

As noted, there are two type of edges in this example concept map. One type of the edge has a hierarchical property, such as one concept consists of another concepts (e.g. “animal” consists of “mammal”). The other type of edge has a peer-to-peer (bi-directional) property, such as one concept is strongly related to another (e.g. “cloud” is related to “rain”). In other examples, the instructor 102 may use more than two types of edges or multiple edges of varying types. Each edge has two factors to define the type of an edge; 1) whether it is directed or undirected, and 2) the label of the edge which defines its semantic meaning.

In one example, after an instructor 102 creates a reference (or “ground truth”) concept map as in FIG. 5A, the concepts that the learners 104 can use to create learner concept maps 332 are then determined, which are those concepts in the instructor's reference concept map 324. Similarly for the edges 204.

FIG. 5B is an example computer-implemented assessment test 500 of the candidate key concepts 206 and the candidate type of edges 104 a learner 104 is to use to create the learner concept map 332 based on the instructor's reference concept map 324. The maximum number of each type of the edges 204 that a learner 104 can use is also determined by the number of that type of edges 204 used in the reference concept map 324. By enforcing these constraints, the assessment is nondiscriminatory for each learner.

There are several ways of auto-assessing the learner concept maps 322 using a processor 302. A comparison may be made by having a processor 302 check the similarity between the learner concept map 322 and the reference concept map 324. A software graphical user interface (GUI) can be executed by the processor 302 to allow a peer-review of the learner concept map 322 may be done by other learners 104 in the class and review of the reviewers used to help provide a check on the peer review as well as provide for additional assessment of the learner 104 based on the feedback on his/her feedback to other learners 104.

Another approach is to have a processor 302 compare the learner concept map 322 with the reference concept map and look for differences of the edges between pairs of concepts in each concept map. Further differences for the processor 302 to check is the difference of paths between the reference concept map 324 and the learner concept map 322. Each candidate concept is given a different weight, which is determined by the processor 302 by the importance of the concept in the learning content 103 and the centrality of the candidate concept in the reference concept map 324. Each type of edge is also given a weight, which is given a default value by the processor and the instructor 102 can change the values of each of the edge weights. More detail follows.

One method of having the processor 302 automatically comparing the learner concept map 332 to a reference concept map 324 involves checking the difference in the relationship of each pair of concepts in the learner's concept map and the corresponding pair of the concepts in the reference concept map. The relationship of each pair of concepts is divided into two parts by the software. One part is the difference of the edges between the same pair of concepts in the two concept maps: Δf (eᵢⱼ, e′ᵢⱼ), where eᵢⱼ is the reference edge between concept I and concept j and e′ᵢⱼ is the edge between concept I and concept j in the learner's concept map. The other part is the difference of the paths between the same pair of concepts in the reference and learner concept maps: Δg(Pᵢⱼ, P′ᵢⱼ) where Pᵢⱼ is the set of paths between concept I and concept j in the reference concept map, and P′ᵢⱼ is the set of paths between concept I and concept j in the learner's concept map. The assessment (grade or score) of the learner's concept map is implemented in software instructions 306 on the processor 302 by the following formula:

$$S = {S}_{m ax} - {\sum }_{i , j ∈ \{ 1 , … , K \}} \vert {θ}_{1} * Δ f ( {e}_{ij} , {e}_{ij}^{′} ) + {θ}_{2} * Δ g ( {P}_{ij} , {P}_{ij}^{′} ) \vert$$

where K is the total number of candidate concepts, θ₁ and θ₂ are two parameters, Sₘₐₓ is the maximum score that one can get.

To further calculate Δf (eᵢⱼ, e′ᵢⱼ) and Δg(Pᵢⱼ,P′ᵢⱼ), weights are assigned to each type of edges. The weight of each type of edge has a default value given by the processor 302, with a directed edge having a weight w₁ and an undirected edge having a weight w₂. In one example, it is assumed that w₁>w₂ (e.g., w₁=2*w₂). In other examples, the instructor may change the weight value for each type of edge. A weight is then calculated for each concept. With those weights, Δ(eᵢⱼ, e′ᵢⱼ) and Δg(Pᵢⱼ, P′ᵢⱼ) are calculated and the details of which are described in FIG. 6.

For the processor 302 to calculate the weight of a concept, the importance of the concept in the learning content 103 is considered based on its frequency in the learning content 103 and the Inverse Document Frequency (IDF) in all global books, the global document set 105, which are widely used in the information retrieval area and known to those of skill in the art. Concepts or terms used to describe the concepts that appear in many documents are considered common and relatively less important. An IDF value of a concept may be measured using instructions 306 on the processor 302 with the following equation:

$$IDF ( {c}_{i} ) = log \frac{n - {n}_{{c}_{i}} + 0.5}{{n}_{{c}_{i}} + 0.5}$$

where n is the total number of documents in the global document set; n_{c}_{ᵢ} is the number of documents in the global document set in a database 330 that contain concept cᵢ. The global document set 105 includes the set of all of the text books in the system 300. In the case where there are not enough text books in the system 300, other types of available documents may be used. The global document set 105 should be large enough to ensure the IDF values are statistically significant.

To be adaptive to the concept relationship, the centrality value of the concept in the instructor reference concept map 324 network is considered by processor 302 for the weight of the concept. For a metric to calculate the centrality value of a concept in the reference concept map 324 network, a modified Page Rank technique may be implemented in software instructions 306 that takes into consideration the weight of the edges 204. The following equation may be used by processor 302 to determine the modified Page Rank values for the nodes in the reference concept map 324 with weighted edges 204. It is a recursive equation:

$$PR ( {c}_{i} ) = \frac{1 - d}{N} + d {\sum }_{j} \{ \frac{w ( {c}_{j} , {c}_{i} )}{{\sum }_{k} w ( {c}_{j} , {c}_{k} )} \cdot PR ( {c}_{j} ) \}$$

where d is a parameter with a typical value of 0.85. Note that d can be optimized for a given type of document set. PR(cᵢ) is the modified PageRank value of node cᵢ, PR(cⱼ) is the modified PageRank value of node cⱼ, w(cⱼ,cₖ) is the weight of the edge 204 from node cⱼ to node cₖ, w(cⱼ,cᵢ) is the weight of the edge 204 from node cⱼ to node cᵢ, N is the total number of nodes in the reference concept map 324.

The weight of concept cᵢ is determined by processor 302 as:

R(cᵢ)=Ø₁*TF(cᵢ)*IDF(cᵢ)+Ø₂*PR(cᵢ)

where Ø₁ and Ø₂ are two parameters and R(cᵢ) is the output weight for concept cᵢ.

Using both the weights of the edge and the weights of the concepts, the following formula may be used by processor 302 and software instructions 306 to determine the difference of the edges between the same pair of concepts in the learner's concept map 322 and the reference concept map 324:

$$Δ f ( {e}_{ij} , {e}_{ij}^{′} ) = \{ \begin{matrix}0 , & if the edge types are the same \\ R ( {c}_{i} ) * R ( {c}_{j} ) * {w}_{ij} , & if the edge types are different\end{matrix}$$

where R(cᵢ) is the weight of concept cᵢ and R(cⱼ) is the output weight for concept cⱼ, wᵢⱼ is the edge weight between concepts cᵢ and cⱼ in the reference concept map 324.

FIG. 6 is an example path score calculation by the processor 302 based on the concept mapping network 600 showing different connection paths between nodes cᵢ and cⱼ. The path score for a pair of concepts is calculated with software instructions 306 based on the concept network. All paths with length equal to 1 and those longer than 1 are considered. Assume the weight between cᵢ and cⱼ is wᵢⱼ. Besides cᵢ, cⱼ also connects to nodes cₖ₁, cₖ₂, . . . , and node cₖₙ. Nodes cₖ₁, cₖ₂, . . . , and node cₖₙ may or may not have paths to connect to node cᵢ. The path score Pᵢⱼ of nodes cᵢ and cⱼ may be determined by the processor 302 and software instructions 306 using the following formula:

$${P}_{ji} = {w}_{ji} + ∝ ( {\sum }_{{m}_{1}} {w}_{{jm}_{1}} {w}_{{m}_{1} i} ) + {∝}^{2} ( {\sum }_{{m}_{1} , {m}_{2}} {w}_{{jm}_{1}} {w}_{{m}_{1} {m}_{2}} {w}_{{m}_{2} i} ) + …$$

where on the right side of the above formula, the first term is from the path of length 1, and the second term is from the paths of length 2, and the third term is from the paths of length 3, . . . . The variable “∝” is a predefined decay parameter with a small value much less than 1, which makes sure that the longer the path, the less of a contribution it will give to the relevancy score. The contribution value of each path with length L to the score is calculated by multiplying the weight of each edge in the path and multiply the decay factor ∝ for (L-1) times. Accordingly, the path difference is determined by the processor 302 and software instructions 306 using the following formula:

66 g(Pᵢⱼ, P′ᵢⱼ)=Pᵢⱼ−P′ᵢⱼ

where Pᵢⱼ is the path score from concept cᵢ to concept cⱼ in the reference concept map. P′ᵢⱼ is the path score from concept cᵢ to concept cⱼ in the learner concept map.

While providing a score based on a learner's understanding of the concept map is useful, the computer-implemented system and method herein provide an opportunity to not only assess the learner's understanding of the learning content 103 but also to improve the understanding by having the learners 104 participate in a peer-review process. This peer-review process helps to engage the learner 104 and helps minimize the time instructors 102 put into helping/tutoring learners 104 in large classes by placing the learners 104 in dual roles of “learner” and “reviewer”. That is, in order to help make the scoring of these constrained or open-ended concept maps scalable for a large set of people (a large on-ground class or an online learning scenario such as a MOOC), the peer concept assessment module 123 is implemented by the processor 302 and instructions 306 to provide a GUI interface that allows learners to review concept maps from other learners, assign review scores and/or comments and then provide feedback to the reviewers of their learner concept maps, which is also used to help calculate an overall score for an individual learner 104. In total, every learner 104 may be evaluated by a sub-set of their class peers for the learner's understanding of the concepts (average or median review scores (or ratings) from the peer-reviewers), and each learner 104 is evaluated for their ability to provide meaningful and constructive feedback to others. That is, every learner's performance may be assessed in both roles, learner and reviewer, and assigned a final assessment result by processor 302.

Another computer-implemented approach to automated assessment that allows for less constraints on the concept and edge labels used is similarity detection of textual blocks such as learner summarization of the concepts conveyed in the context map. In the similarity module 128 of FIG. 1, the learner concept map 322 may include open-ended labels and textual summaries along with the discussed constrained concept map organization. The open-ended learner concept map 322′ is compared by processor 302 to both the instructor reference concept map and the learning content 103 to uncover gaps in the learner's understanding, the prevalence of misconceptions about a topic, and provide automated customized new learning content material by suggesting new extra learning content based on previous learner 104 experience and the instructor 102 feedback and direction.

In the similarity module 128, a set of summaries related to the topic under assessment for the course is selected from the learning contents by the instructor 102. For instance, the summary can be the reference concept map 324 which can be auto generated by processor 302 as described along with textual summaries or the textual summaries created/modified by the instructor 102 or combinations thereof. The instructor 102 may suggest to processor 302 via a GUI interface reserve material within the learning content 103 to be provided to the learners 104 as complimentary topics. The learner's review the topic learning content and enter their own textual summaries in learner concept maps from candidate concepts 206 as chosen by the computer-implemented system or the instructor 102.

At assessment time, the similarity module 128 uses similarity detection using summarization techniques to detect the textual similarity and/or differences between the summary or learner concept map 322, the instructor 102 reference concept map 324, and the topical material in the learning content 103. The textual summarization techniques may use software-based statistical language models and/or singular value decomposition (SVD) and Karhunen-Loeve (KL) expansion divergence methods to check the learner 104 understanding. Other such textual summarization techniques may include: glossaries, computational linguistics, natural language processing, domain ontology, subject indexing, taxonomy, terminology, text mining, and text simplification to just name a few. In addition, various text similarity detection APIs exist and are known and available to those of skill in the art.

The similarity module may also include a reserve material suggestion module that uses the assessment scores as weightings for the atomic components (words, etc.) of each topic previously defined. These weighting can then be used to direct the final weightings of one or more software-based summarization (or key word extraction) engine modules. The extraction summary obtained for the output may then be compared (subtracted from) the summary obtained from the reference material 103. The lower an assessment for a learner 104 in a specific topic, the larger the weight to be used to choose summaries to provide additional content for that particular topic, and vice versa.

Topical content in the learning content 103 that is not in the summary (or learner content map) and not indicated as successfully understood by the learner 104 is then indicated by processor 302 for the learner 104 and may be sent to the instructor 102 prior to the learner 104 for review, approval, changes, etc. using a software-based GUI interface as needed in the final assessment dashboard 132 in FIG. 1. This extra content suggestion approach provides an intelligent system to automatically detect poor learning and address that poor learning with new content and/or lessons for broad learning as well as to master proficiency.

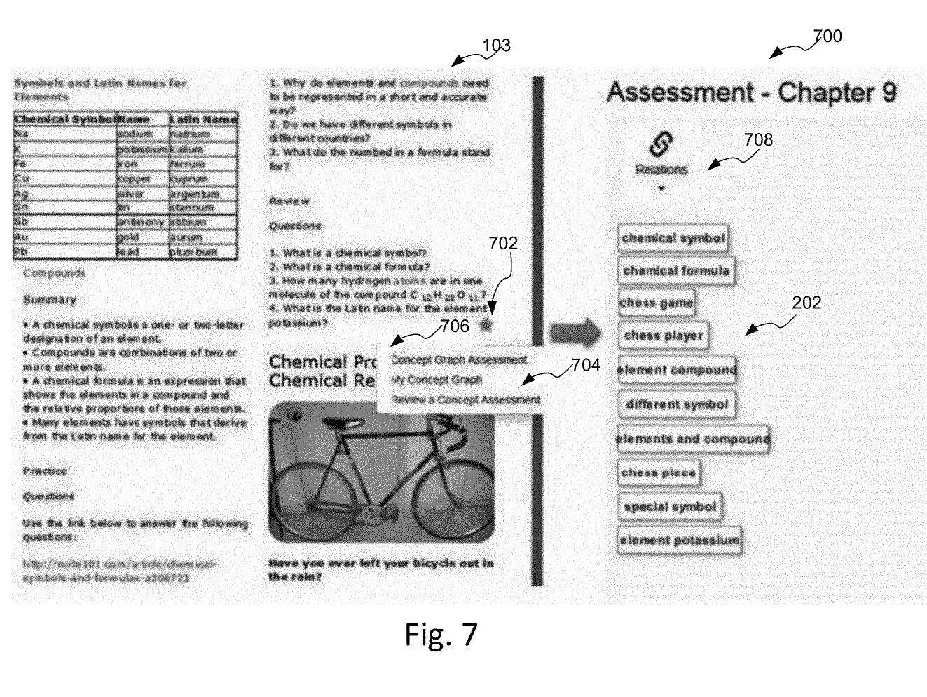

FIG. 7 is a first screenshot 700 of one example computer-implemented assessment system that presents via a GUI interface some learning content 103 on the left. At the end of content block in the learning content 103, in one example, a gold star or other icon 702 is presented to the learner 104. The learner 104 can select the gold star 702 to begin the assess map module by simply clicking the gold star 702 and choose “Concept Graph (Map) Assessment” 704 from the pop-up menu 706. The detected key concepts 202 that underlie this content block are presented by the processor 302 for the learners 104 to review on the right side of the screen. Learners 104 can drag the concepts and put them where they like on the right side of the screen. Then the learners 104 can connect the various key concepts based on their understanding by selecting edge relations 708.

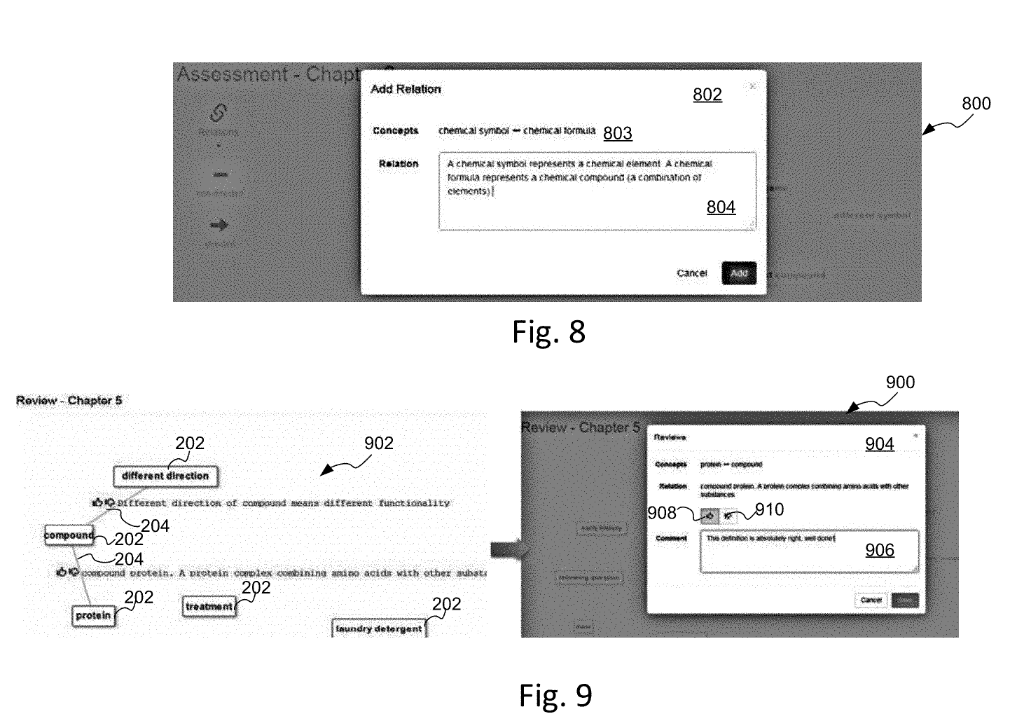

FIG. 8 is an illustration of an example software-based GUI interface second screenshot 800 for concept edge relation construction by a learner 104. In this example, an add relation window 802 presents the concepts “chemical symbol” and “chemical formula” that are linked together by the learner 104. The relation is entered by the learner 104 is “A chemical symbol represents a chemical element. A chemical formula represent a chemical compound (a combination of elements)” in the relation text box 804. This is but one type of open-ended connecting that does not put any rule constraints about how the pair of concepts should be connected. Learners 104 may freely define the relationship between concepts based on their understanding. In other examples some constraint rules may be added to the edges to orient the concept pair definition. For instance, the utility could ask for connecting concepts textual input that creates a grammatically correct sentence, where one concept begins the sentence and the other concept ends the sentence and the words in between describe the relationship. In other examples, the relationships allowed may be presented and the believed proper one selected. For instance, “a chemical formula” “consists of” “chemical symbol” may be one option, where “consists of” is a pre-defined relation.

FIG. 9 is an illustration of an example third software-based GUI interface screenshot 900 for the peer concept map assessment module 123 in FIG. 1. After the learners 104 finish the concept construction and pairwise edge definitions, they may submit the constructed learner concept map 232. This learner concept map 232 is then ready for other learners to review. The reviewer system view 902 may be like the left side of FIG. 9 showing the learner concept map 232 concepts 202 and edges 204 as interconnected. A reviewer may mark each concept pair definition right or wrong in the GUI interface by simply clicking a green 908 or red 910 hand, in one example. A small pop-up window 904 allows a reviewer to input any review comments 906 in a comments text box. This is but one example design that allows reviewers to rate the concept maps. Another example may allow the reviewer to also rate or score on a scale, such as 1 to 5, for every pair of the connected concepts. This last approach is especially useful when there is rarely a right or wrong pair of concept definition.

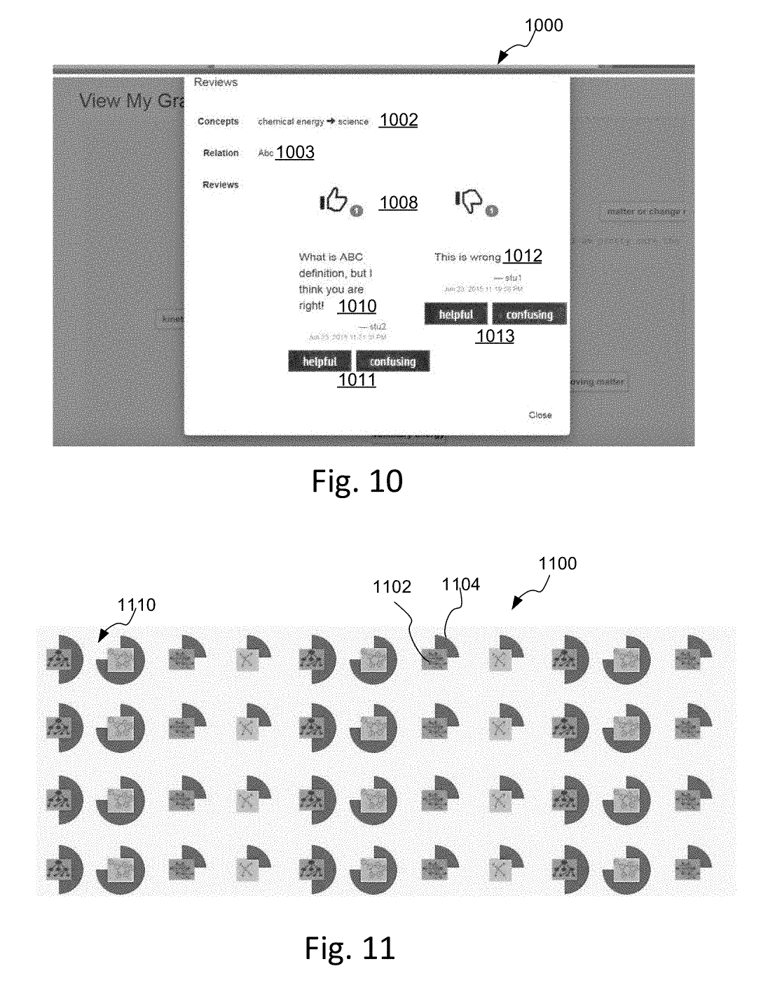

FIG. 10 is an example illustration of fourth software-based GUI interface screenshot 1000 for the review module 125 in FIG. 1. It is believed that how well a learner 104 assesses another's work is an effective approach to improve the learner assessment process. Therefore, after the period of review of other learner's concept map ends, the learner 104 is presented with the reviews by other learners by the GUI interface and may be allowed to provide feedback to the reviewer comments they received. Along with a presentation of the concepts 1002 and the relation between the concepts 103, the learner 104 may select “helpful” or “confusing” in choice sections 1011 and 1013 (the choice for each review denoted by thumbs up or thumbs down, respectively, symbol 1008 in this example) to review comments 1010, 1012 that have been received. The more helpful feedback comments one reviewer receives, the better performance the one reviewer achieves for the peer-review portion of the assessment.

FIG. 11 is an example illustration of a software-based GUI interface assessment dashboard 1100 with a Heat Map view The dashboard 1100 may be generated to allow an instructor 102 to track the progress of each learner from a high level view using a Heat Map view 1110 where each icon represent a learner 104. The center 1102 of the icon for the learner 104 may include a thumbnail of the submitted learner concept map 322. The color of the thumbnail may represent the performance of this learner's concept map 324 and/or alternatively the average or median scores from peer-reviewers. The outside pie chart 1104 may represent the performance of the learner 104 as a reviewer (the percent of reviews that received “helpful” ratings). The map scores may be color coded (only gray-scale shown), where for instance red indicates a low average score from all reviewers, green is a high average score, and yellow is in-between (cut points may be automatically set based on class distribution, and may be manually set by the instructor). The outside pie chart 1104 may be colored blue to represent the reviewer feedback and may not be color coded, rather, the extent of the arc represents the percent of positive feedback (thumbs up affirmation). With this heat map view 1110, the instructor 102 can quickly have an overall view of learners in both learner and reviewer role. Although, a Heat Map may be used for an instructor dashboard, other instructor dashboards could be used as well.

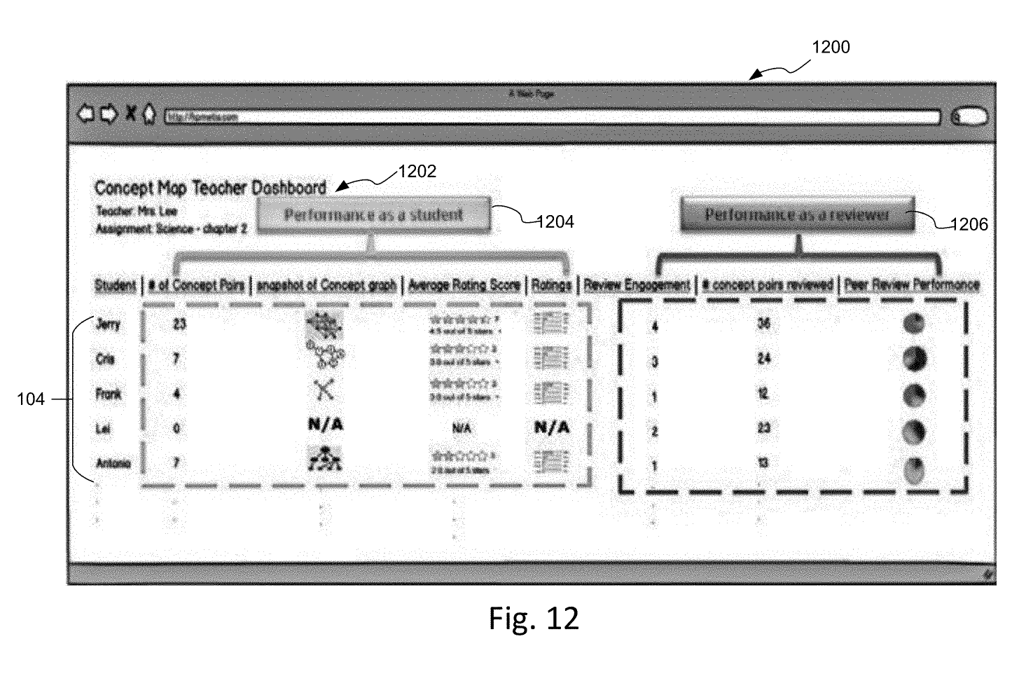

FIG. 12 is an example illustration of an alternative software-based GUI interface instructor dashboard 1200 in a table view 1202 with the learning performance 1204 of the learner 104 on the left and the reviewer performance 1206 of the learner 104 on the right. Various assessment factors for each learner 104 may be presented by processor 302, such as the number of concept pairs related, snapshots of the concept map, their average or median rating score by peer-reviewers, their calculated score or ratings as compared to the instructor's reference concept map. For their role as a reviewer, the various assessment factors displayed by processor 302 may include how may reviews they engaged in, the number, their peer-review performance, and their relative engagement in the review process as compared to the other learners.

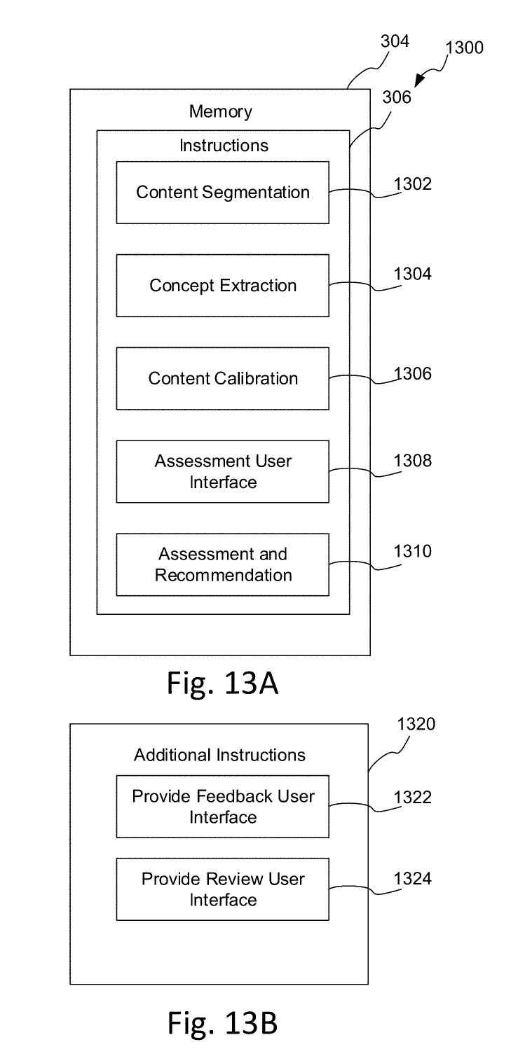

FIG. 13A is an example tangible non-transitory computer readable medium 1300 loadable into memory 304 comprising instructions 306 that when executed on a processor 302 cause the processor 302 to a) in a content segmentation module 1302 create content blocks from a set of learning content 103; b) in a concept extraction module 1304 extract a set of key concepts 326 from each content block and provide a set of weights for the set of key concepts 326 in the set of learning content 103; c) in a content calibration module 1306 provide a concept calibration user interface to an instructor to allow for altering the set of key concepts 326 and the set of weights from each content block thereby creating a reference set of concepts and a reference concept map 324; d) in an assessment user interface module 1308 provide an assessment user interface to a learner to allow the learner to build a concept map diagram connecting the key concepts 326 with edges describing their relationships; and e) in an assessment and recommendation module 1310 assess the concept map diagram of the learner with respect to a reference concept map 324 of the instructor 102 to provide an automated assessment.

FIG. 13B is an example set of possible additional instructions 1320 on non-transitory computer readable medium 1300 loadable into memory 304. The non-transitory computer readable medium 1300 may include instructions to: f) provide a feedback user interface 1322 to the learner 104 including a set of concept maps 332 created by other learners for the learner 104to review and provide feedback; and g) provide a review user interface 1324 to the learner 104 to present the feedback of other learners to the concept map diagram 332 of the learner 104 and to allow the learner 104 to provide a reviewer score based on the learner's assessment of the feedback of another learner to the concept map of the learner 332, wherein the automated assessment includes a portion based on the reviewer scores of other learners to the feedback provided by the learner.

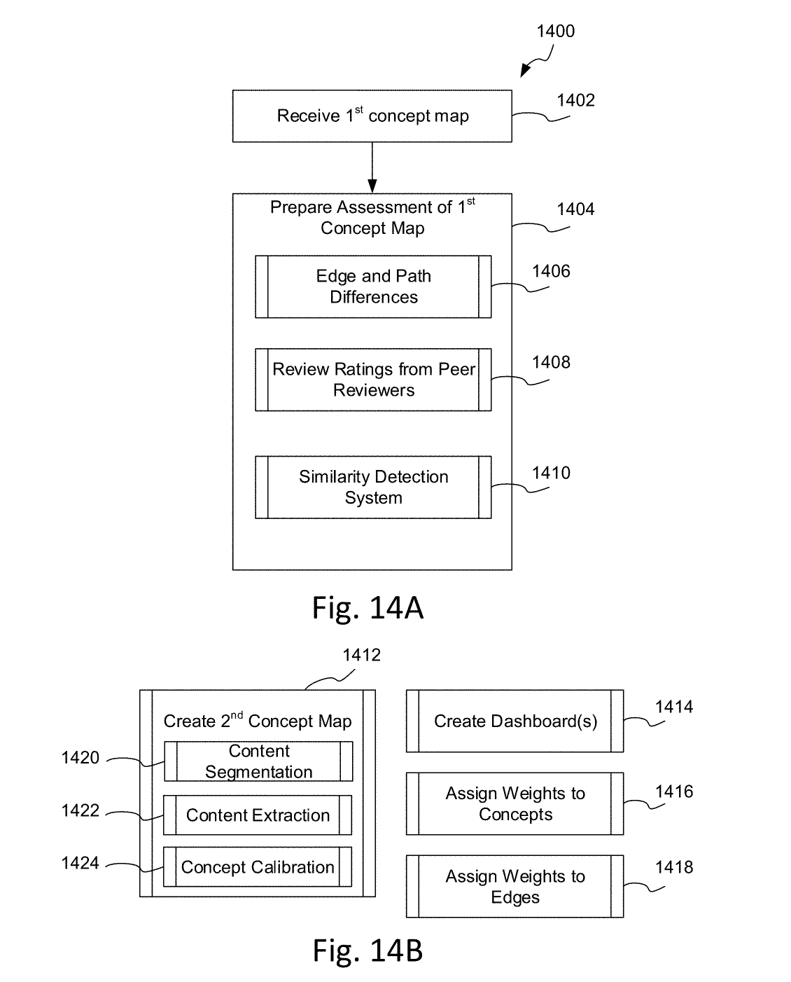

FIG. 14A is an example computer-implemented method 1400 executed by instructions 306 for concept map assessment. The method 1400 includes a) receiving 1402 by processor 302 a first concept map with a first set of edges each with an edge type and a first set of concepts from a learner 104; b) preparing by processor 302 executing instructions organized in modules an assessment 1404 of the first concept map for the learner 104 based on at least one of: i) and edge and path difference module 1406 to determine an amount of edge difference between the first set of edges and a second set of edges each with an edge type of a second concept map and an amount of path differences between the first set of concepts and a second set of concepts of the second concept map, and ii) a review ratings from peer-reviewers module 1408 to review ratings from peer-reviews of the first concept map by other learners and a score based on feedback for reviews done by the learner 104 from the other learners; and iii) a similarity detection system module 1410 to using software-based summarization techniques to detect similarity between the first concept map, the second concept map, and a set of learning content.

FIG. 14B is an example set of possible additional computer implemented methods that may include a create second concept map method 1412 to create the second concept map with the second set of edges and the second set of concepts by an instructor using instructions 306 to implement at least one of content segmentation 1420, content extraction 1422, and concept calibration 1424 from the set of learning content 103. Other methods include a create software-based GUI interface dashboard method 1414 wherein calculating the assessment includes creating a dashboard for at least one of the learner and the instructor and may include performance of the learner as a reviewer and performance of the learner based on the peer reviews. The create dashboard method 1414 GUI interface may include an assessment (grade or score) and suggested learning content material based on the amount of edge differences and the amount of path differences.

Additionally, a computer-implemented assign weights and concepts method 1416 may include wherein different weights are assigned to each concept in the second set of concepts based on a determination of the relative importance of the respective concept to the other concepts in the second set of concepts. The assign weights to concepts method 1416 includes wherein the different weights assigned to each concept by processor 302 in the second set of concepts is based on at least an inverse document frequency in references used in the field of the concepts and wherein the different weights assigned by processor 302 to each concept in the second set of concepts is based on at least a page-rank algorithm that considers the weight of the edges in the second set of edges.

The computer-implemented method 1400 may include an assign weights to edges method 1418 wherein the instructor determines the second set of edges and different weights are assigned by the instructor to each edge in the second set of edges or wherein each edge type in the first and second set of edges is defined by whether the respective edge is directed or undirected and a label that defines its semantic meaning. Other methods to method 1400 include wherein the edge difference determined by processor 302 is a product of the weight of a first concept and the weight of a second concept and the edge weight between the first concept and the second concept in the second concept map if the edge types are different or wherein the path difference is determined by processor 302 based on a weight of each edge between two concepts and a decay factor based on path length in the first concept map.

While the claimed subject matter has been particularly shown and described with reference to the foregoing examples, those skilled in the art will understand that many variations may be made therein without departing from the intended scope of subject matter in the following claims. This description should be understood to include all novel and non-obvious combinations of elements described herein, and claims may be presented in this or a later application to any novel and non-obvious combination of these elements. The foregoing examples are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A computer-implemented method of concept map assessment by a processor coupled to computer readable memory having instructions to cause the processor to implement operations, comprising:
receiving a first concept map with a first set of edges and a first set of concepts from a learner;
preparing an assessment of the first concept map for the learner based on at least one of:
a) an amount of edge difference between the first set of edges and a second sets of edges of a second concept map and an amount of path differences between the first set of concepts and a second set of concepts of the second concept map,
b) a similarity detection system to detect similarity in text between the first concept map, the second concept map, and a set of learning content, and
c) review ratings from peer-reviews of the first concept map by other learners and a score based on feedback for peer-reviews done by the learner from the other learners.

2. The method of claim 1, further comprising creating the second concept map with the second set of edges and the second set of concepts using at least one of content segmentation, content extraction, and concept calibration from the set of learning content.

3. The method of claim 1 wherein preparing the assessment further comprises:
d) creating a dashboard for at least one of the learner and the instructor and the dashboard includes at least one of performance of the learner by the assessment i) of a), ii) of b), iii) based on the score in c), and iv) based on the review ratings in c).

4. The method of claim 1 wherein different weights are assigned to each concept in the second set of concepts based on a determination of the relative importance of the respective concept to the other concepts in the second set of concepts.

5. The method of claim 4 wherein the different weights assigned to each concept in the second set of concepts is based on at least an inverse document frequency in references used in the field of the concepts.

6. The method of claim 4 wherein the different weights assigned to each concept in the second set of concepts is based on at least a modified page-rank algorithm that considers the weight of the edges in the second set of edges.

7. The method of claim 1 wherein the edge difference is a product of the weight of a first concept and the weight of a second concept and the edge weight between the first concept and the second concept in the second concept map if the edge types are different.

8. The method of claim 1 wherein the path difference is calculated based on a weight of each edge between two concepts and a decay factor based on path length in the first concept map.

9. A system for concept map assessment, comprising:
a processor;
a memory coupled to the processor, the memory including instructions that when read by the processor cause the processor to:
allow learners to create a learner concept map with a set of edges connecting a set of concepts; and
perform at least one of the operations to:
compare and assess the learner concept map to a reference concept map based on an amount of edge differences and an amount of path differences between the reference concept map and the learner concept map;
provide a peer-review assessment system to the learners to review and provide feedback to a set of other learner concept maps and to allow the learner to review feedback from other learners for the learner concept map and provide feedback on feedback; and
compare and assess the learner concept map to the reference concept map using similarity detection to detect similarities in text between the learner concept map, the reference concept map and a set of learning content in a database.

10. The system of claim 9 further comprising instructions to create an assessment that includes the understanding of the learning based on the comparison of the learner concept map to the reference concept map and the feedback of other learners to the learner feedback to other learners.

11. The system of claim 10 further comprising instructions to create a dashboard for at least one of the learner and the educator and the dashboard includes both an assessment of the learner and an assessment of the learner as a reviewer of other learners.

12. The system of claim 9 further comprising instructions to generate the set of key concepts from content blocks in the set of learning content in the database and to allow learners to connect pairs of concepts with edges defining the pairs of concepts inter-relationships using at least one of content segmentation, concept extraction, and concept calibration.

13. The system of claim 9 wherein the similarity detection includes a reserve material suggestion system to provide suggested learning content based on the assessment of the learner.

14. A non-transitory computer readable medium comprising instructions that when executed on a processor cause the processor to:
assess a concept map diagram of a learner with respect to a reference concept map to provide an automated assessment based on at least one of:
edge and path differences between the concept map of the learner and the reference concept map,
similarity detection to detect similarity in text between the concept map diagram of the learner, the reference concept map, and a set of learning content, and
scores from peer reviews by other learners of the concept map diagram of the learner and rating of the learner's peer review scores by other learners.

15. The non-transitory computer readable medium of claim 14 further including instructions to:
create content blocks from the set of learning content;
extract a set of key concepts from each content block and provide a set of weights for the set of key concepts in the set of learning content;
provide a concept calibration user interface to allow for altering the set of key concepts and the set of weights from each content block thereby creating a reference set of concepts and the reference concept map; and
provide an assessment user interface to the learner to allow the learner to build the concept map diagram connecting the key concepts with edges describing their relationships and paths within concept blocks.
